(19) United States
(12) Patent Application Publication
(10) Pub. No.: US 2010/0195616 A1
(43) Pub. Date: Aug. 5, 2010

(54) Handover From Circuit Switched Over Packet Switched Domain to Circuit Switched Domain

(76) Inventors: Jari Vikberg, Jarna (SE); Magnus Hallenstal, Taby (SE); Göran Rune, Linkoping (SE); Arne Pehrsson, Huddinge (SE); Andreas Witzel, Herzogenrath (DE)

Correspondence Address: ERICSSON INC., 6300 LEGACY DRIVE, M/S EVR 1-C-11, PLANO, TX, 75024, US

(21) Appl. No.: 12/663,601

(22) PCT Filed: Jun. 8, 2007
(86) PCT No.: PCT/EP2007/055678

§ 371 Date: Apr. 12, 2010

(51) Int. Cl. H04W 36/00; H04L 12/66

(52) U.S. Cl. 370/331; 370/356

(57) ABSTRACT

A method for initiating handover of a circuit switched service using a packet switched bearer of a mobile station (31) from a packet switched domain to a circuit switched MS eNodeB PMSC PCRF domain in a mobile communications network comprising a radio network and a core network, said method comprising communicating to the mobile station that a circuit switched handover procedure is to be initiated, said communication comprising sending a circuit switched handover required message to the mobile station, said circuit switched handover required message comprising identification of a circuit switched handover target cell; said mobile station sending a circuit switched handover required message to the core network, said handover-required message comprising identification of the handover target cell.

### TECHNICAL FIELD

The invention relates to a handover control mechanism for a mobile communication system. In particular, the invention relates to a method and apparatus for triggering the seamless handover of an established connection from circuit switched over packet switched domain to circuit switched domain, for example a Voice-over-IP call.

### BACKGROUND

IP Multimedia (IPMM) services provide a dynamic combination of voice, video, messaging, data, etc, within the same session. By growing the numbers of basic applications and the media which it is possible to combine, the number of services offered to the end users will grow, and the inter-personal communication experience will be enriched. This will lead to a new generation of personalised, rich multimedia communication services, including so-called “combinational IP Multimedia” services.

IP Multimedia Subsystem (IMS) is the technology defined by the Third Generation Partnership Project (3GPP) to provide IP Multimedia services over mobile communication networks. IMS provides key features to enrich the end-user person-to-person communication experience through the integration and interaction of services. IMS allows new rich person-to-person (client-to-client) as well as person-to-content (client-to-server) communications over an IP-based network. The IMS makes use of the Session Initiation Protocol (SIP) to set up and control calls or sessions between user terminals (or user terminals and application servers). The Session Description Protocol (SDP), carried by SIP signaling, is used to describe and negotiate the media components of the session. Whilst SIP was created as a user-to-user protocol, IMS allows operators and service providers to control user access to services and to charge users accordingly. Other protocols are used for media transmission and control, such as Real-time Transport Protocol and Real-time Transport Control Protocol (RTP/RTCP), Message Session Relay Protocol (MSRP), and Hyper Text Transfer Protocol (HTTP). IMS requires an IP based access network which for example could be a 3GPP Packet Switched (PS) network, or some other access network such a fixed broadband or WiFi network.

A fundamental requirement for real-time service provision is the seamless handover of services for subscribers roaming across cell boundaries of the radio access network (RAN). Traditional circuit switched (CS) based call services have been designed to meet this requirement. In the case of 2G and currently implemented 3G networks, PS real time handover with low latency is not provided for although service continuity is achieved at the terminal side by ordering a session to be moved from one cell to another, i.e. there is no prepare phase to shorten latency when moving cell.

Real time PS handover is standardized in 3GPP for 3G networks, but the feature has not yet been deployed. It is expected that when High-Speed Downlink Packet Access (HSDPA) is deployed, or shortly thereafter, the mechanisms needed for fast PS handover will be also be deployed. In the initial implementation stage, roll-out of this feature across 3G networks will inevitably be patchy. For 2G networks, fast and efficient PS handover procedures in the packet switched (PS) domain within the 2G network (and between 2G and 3G networks) have only recently been standardized in 3GPP TS 43.129 for GSM/EDGE networks but are not yet deployed. Support for PS handover in 2G networks is never likely to be comprehensive (if implemented at all), yet handover of PS calls would be desirable as 2G networks will continue to provide a fallback network for 3G subscribers in the case of limited 3G network coverage. It can also be expected that the next generation radio and core network which are currently being specified under the name LTE (Long Term Evolution) and SAE (System Architecture Evolution) in 3GPP will also have limited coverage, and that these networks will also require fallback to 3G and 2G networks.

It is expected that in the future a major user of PS services will be Voice-over-IP (VoIP) applications. VoIP calls will be particularly sensitive to even relatively minor service interruptions caused by inter-cell handovers. As long as a terminal engaged in a VoIP call can perform PS handover to another cell (the “target cell”), the interruption can be kept short enough to avoid any noticeable drop in perceived quality. However, if either the current cell or the target cell do not support PS handover, a noticeable interruption is likely to occur as packets will be lost during the transition period. Consequently, until all RAN cells support PS handover, the provision of IMS services such as voice and video calls utilising the PS domain are likely to result in users receiving a reduced quality of service when crossing cell boundaries.

Mobile circuit switched (CS) services based on GSM and WCDMA radio access are a world-wide success story and allow obtaining telecommunication services with a single subscription in almost all countries of the world. Also today, the number of CS subscribers is still growing rapidly, boosted by the role out of mobile CS services in dense population countries such as India and China. This success is furthermore extended by the evolution of the classical Mobile Switching Centre (MSC) architecture into a softswitch solution which allows using packet transport infrastructure for mobile CS services.

Recently the 3GPP work item “Evolved UTRA and UTRAN” (started in summer 2006) defined a Long-Term Evolution (LTE) concept that assures competitiveness of 3GPP-based access technology. It was preceded by an extensive evaluation phase of possible features and techniques in the RAN workgroups that concluded that the agreed system concepts can meet most of the requirements and no significant issue was identified in terms of feasibility.

LTE will use orthogonal frequency division multiplexing (OFDM) radio technology in the downlink and single-carrier frequency division multiple access (SC-FDMA) for the uplink, allowing at least 100 Mbps peak data rate for downlink data rate and 50 Mbps for uplink data rate. LTE radio can operate in different frequency bands and is therefore very flexible for deployment in different regions of the world.

FIG. 1 illustrates schematically the System Architecture Evolution (SAE) and LTE interfaces. In parallel to the RAN standardization 3GPP also drives a System Architecture Evolution (SAE) work item to develop an evolved core network (CN). The SAE core network is made up of core nodes, which are further divided into Control Plane (Mobility Management Entity (MME) 21) and User Plane Gateway 22 (Serving Gateway and PDN Gateway) nodes. In the context of the present invention, the terms Access Gateway (AGW) and SAE GW are used to depict both the Serving Gateway and the PDN Gateway nodes and functions. In the terminology currently used AGW-UP contains both User Plane Entity (UPE) and Inter-Access Anchor (IASA) functionality. The MME 21 is connected to the E-UTRAN NodeB (eNodeB 23, 23′) via the S1-MME interface and the Serving Gateway 22 is connected to the eNodeB 23, 23′ via the S1-U interface.

Common to both LTE and SAE is that only a Packet Switched (PS) domain will be specified, i.e. all services are to be supported via this domain. GSM (GPRS) and WCDMA however provide both PS and Circuit Switched (CS) access simultaneously.

Hence, if telephony services shall be deployed over LTE radio access and SAE core networks, an IMS based service engine (or similar) is needed. It has been recently investigated how to use LTE/SAE as access technology to the existing Mobile Switching Subsystem (MSS) infrastructure. The investigated solutions are called “CS over LTE/SAE”, or briefly just “CS over LTE” (CSoLTE), solutions.

The basic CSoLTE architecture for these solutions is shown in FIG. 2. The Packet Mobile Switching Center (PMSC) 24 can be serving both traditional 2G and 3G RANs 41 and the new CS over LTE based solutions 42. In addition to MSC-S 29 and MGW 30, Packet MSC 24 contains two new logical functions called Packet CS Controller (PCSC) 27 and Interworking Unit (IWU) 28 that are further described in relation to FIG. 3. A public switched telephone network 43 and a public data network 44 provide connectivity.

In relation to both FIGS. 2 and 3, the communication between the terminal and the PMSC 24 is based on the standard Gi interface which is also called as a SGi interface in the SAE terminology. This means that all direct communication between the terminal and the PCSC 27 and the IWU 28 in the PMSC 24 is based on Internet Protocol (IP) and that the terminal is visible and reachable using an IP-address via the Access Gateway (AGW) 22. This communication between the terminal 31 and the PMSC 24 is divided into two different interfaces, U8c for the control plane and U8u for the user plane. The U8c is terminated in the PCSC 27 and the PCSC 27 has also an Rx interface to the Policy and Charging Rule Function (PCRF) 33 for authorising of LTE/SAE bearers. The U8u is terminated in the IWU 28.

One solution for providing CS services over the LTE radio access is called “CS Fallback” and means that the terminal is performing SAE Mobility Management (MM) procedures towards the MME 21 while camping on LTE access 42. The MME registers the terminal in the MSC-Server (MSC-S 29) for CS based services. When a mobile terminating call or other transaction request resulting in a page for CS services is received in the MSC-S it is forwarded to the terminal via the MME and then the terminal performs fallback to the 2G or 3G RANs. Similar behavior applies for Mobile originated CS services and when these are triggered and the terminal is camping on LTE access, it will fallback to 2G or 3G RANs and trigger the initiation of the CS service there.

The CSoLTE control plane protocol architecture between the terminal 31 and the PMSC 24 (i.e. the U8c interface) is shown in FIG. 4. Interposed between the two is the eNodeB 23 and the AGW 22. This architecture is based on IP protocols (IP, TCP, UDP) and an additional tunnelling protocol named as U8-Circuit Switched Resources (U8-CSR). This protocol carries the Mobility Management (MM) and all the protocol layers above MM transparently between the terminal 31 and the PMSC 24.

The CSoLTE user plane protocols between the terminal 31 and the PMSC 24 (i.e. the U8u interface) are shown in FIG. 5. EnodeB 23 and AGW 22 are arranged between the two. This architecture is based on IP protocols (IP, UDP, RTP) that are used to transmit the necessary voice and data communicating (e.g. AMR coded voice) between the terminal 31 and the PMSC 24.

No known solutions exist for Handover from the CSoLTE based solutions to traditional CS domain.

It is an object of the present invention to obviate at least some of the above disadvantages and to provide a method and apparatus for triggering the seamless handover of an established connection from a circuit switched service over packet switched domain to a circuit switched domain.

### SUMMARY

According to a first aspect of the present invention, there is provided a method for initiating handover of a circuit switched service using a packet switched bearer of a mobile station from a packet switched (CSoLTE) domain to a circuit switched (CS) domain in a mobile communications network comprising a radio network and a core network. It is communicated to the mobile station that a circuit switched handover procedure is to be initiated, said communication comprising sending a circuit switched handover required message to the mobile station, said circuit switched handover required message comprising identification of a circuit switched handover target cell. The mobile station sends a circuit switched handover required message to the circuit switched core network handling said communication, said handover-required message comprising identification of the handover target cell.

According to a second aspect of the present invention, there is provided a method for initiating handover of a circuit switched service using a packet switched bearer of a mobile station from a packet switched domain to a circuit switched domain in a mobile communication network comprising a radio network and a core network. The mobile station receives a communication that a circuit switched handover procedure is to be initiated, said communication comprising a circuit switched handover required message, said circuit switched handover required message comprising identification of a circuit switched handover target cell. The mobile station sends a circuit switched handover required message to the core network, said handover-required message comprising identification of the handover target cell.

According to a third aspect of the present invention, there is provided a mobile station adapted for assisting in initiating handover of a circuit switched service using a packet switched bearer of the mobile station from a packet switched domain to a circuit switched domain in a mobile communication network comprising a radio network and a core network. The mobile station comprises means for receiving a communication that a circuit switched handover procedure is to be initiated, said communication comprising a circuit switched handover required message, said circuit switched handover required message comprising identification of a circuit switched handover target cell, and means for sending a circuit switched handover required message to the circuit switched core network, said handover-required message comprising identification of the handover target cell.

According to a fourth aspect of the present invention, there is provided a method for initiating handover of a circuit switched service using a packet switched bearer of a mobile station) from a packet switched domain to a circuit switched domain in a mobile communications network comprising a radio network, a handover-deciding node and a core network. The handover-deciding node determines whether the mobile station is using packet switched communication services. The handover deciding node sends a communication to the mobile station indicating that a circuit switched handover procedure is to be initiated, said communication comprising a circuit switched handover required message, said circuit switched handover required message comprising identification of a circuit switched handover target cell.

According to a fifth aspect of the present invention, there is provided a handover-deciding node adapted to assist in initiating handover of a circuit switched service using a packet switched bearer of a mobile station from a packet switched domain to a circuit switched domain in a mobile communications network comprising a radio network, and a core network. The handover-deciding node comprises means for determining whether the mobile station is using packet switched communication services, and means for sending a communication to the mobile station indicating that a circuit switched handover procedure is to be initiated, said communication comprising a circuit switched handover required message, said circuit switched handover required message comprising identification of a circuit switched handover target cell.

An advantage of the present invention is that the CSoLTE calls in LTE/SAE access may be moved to 2G/3G RAN CS domain when the LTE coverage is lost.

Moreover no changes are needed to the existing CS CN infrastructure (i.e. the other MSCs than the PMSC may remain unmodified).

### BRIEF DESCRIPTION OF THE DRAWINGS

FIG. 1 illustrates schematically SAE and LTE interfaces.

FIG. 2 illustrates schematically a CSoLTE architecture.

FIG. 3 illustrates schematically a CSoLTE reference architecture.

FIG. 4 illustrates schematically a CSoLTE control plane protocol architecture.

FIG. 5 illustrates schematically a CSoLTE user plane protocol architecture.

FIG. 6 illustrates schematically a handover from CSoLTE to CS: before execution—scenario 1.

FIG. 7 illustrates schematically a Handover from CSoLTE to CS: after execution—scenario 1.

FIG. 8 illustrates schematically a Handover from CSoLTE to CS: before execution—scenario 2.

FIG. 9 illustrates schematically a Handover from CSoLTE to CS: after execution—scenario 2.

FIG. 9B illustrates schematically how the network informs the eNodeB about “CSoLTE call”.

FIG. 10 illustrates schematically a MO call using CSoLTE: Terminal informs the eNodeB about “CSoLTE call”.

FIG. 11. illustrates schematically a MT call using CSoLTE: Terminal informs the eNodeB about “CSoLTE call”.

FIG. 12. illustrates schematically a Sequence Diagram for Handover from CSoLTE to UTRAN CS—scenario 1.

FIG. 13. illustrates schematically a Sequence Diagram for Handover from CSoLTE to UTRAN CS—scenario 2.

FIG. 14. illustrates schematically a Sequence Diagram for Handover from CSoLTE to GERAN CS.

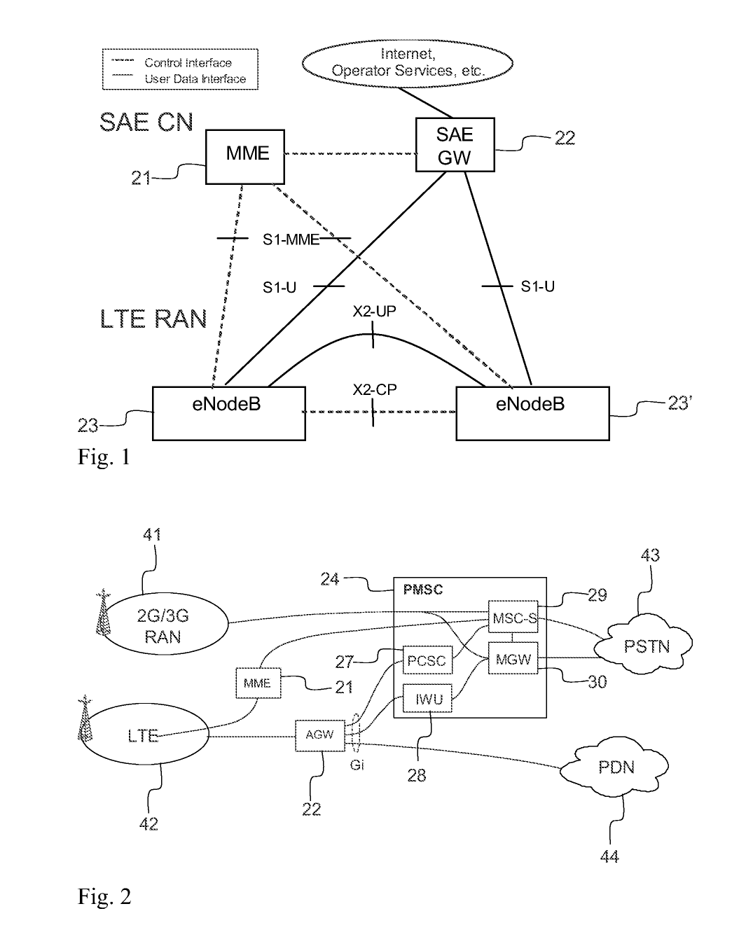

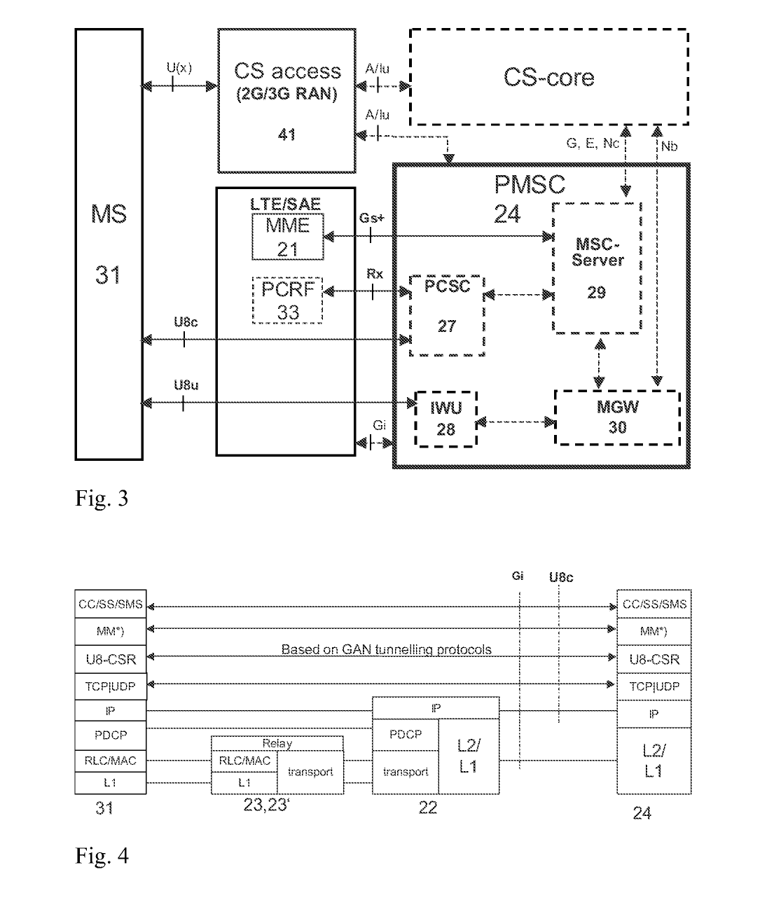

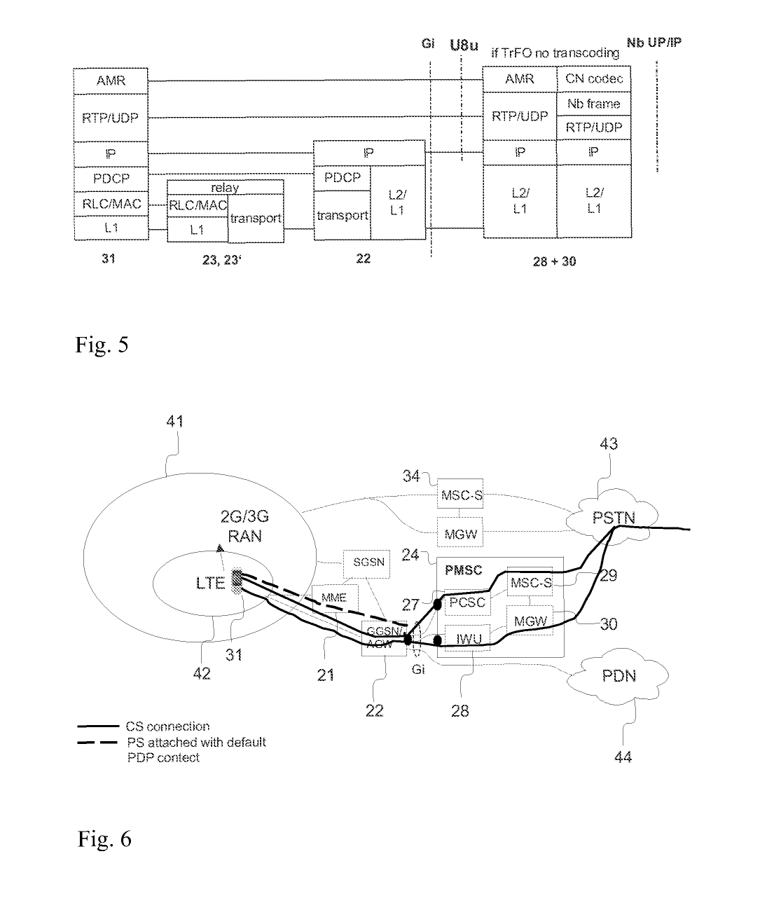

### DETAILED DESCRIPTION

The present invention relates to handover from the CSoLTE based solutions to traditional CS domain (i.e. a 2G and/or a 3G RAN). It applies for the case when a terminal in CS dedicated state (over the CSoLTE solutions) is moving away from LTE coverage (i.e. is about to loose LTE coverage) to the 2G/3G RAN coverage area and when it is preferred to keep the CS connection or service and the call is handed over to the 2G/3G RAN coverage. The CS dedicated state or CS connection could mean that the terminal is engaged in CS call or some other CS related signaling transaction.

This also means that this invention applies for the CSoLTE-I and CSoLTE-D solutions as these solutions contain the usage of CSoLTE principles to transfer user plane and CS signaling connections.

The basic concept of the invention is that Handover from CSoLTE solutions is triggered to the traditional CS domain (i.e. the 2G/3G RAN). The triggering of this handover case means that the relevant LTE node (eNodeB 23) needs to know when the terminal 31 is engaged in a CS (or CSoLTE) call and preferably also which LTE/SAE bearers are being used for the CS call.

Once the eNodeB 23 triggers this handover case, it consists of two parallel handover requests, one request similar to the existing CS Handover request in the CN and the second one similar to the existing PS handover request. The main difference is that the CS Handover request is sent from the eNodeB 23 to the terminal 31, which then forwards it to the PMSC 24. Finally, the eNodeB 23 coordinates that both the CS and PS handover preparations phases are performed and commands the MS 31 to perform handover to the traditional CS domain. In addition, other PS services may also be handed over to the PS domain of the target radio access network (RAN) i.e. GSM or WCDMA radio access networks.

The situation that the present invention addresses is the following:

The terminal is initially:

1. in CS dedicated state via CSoLTE with reserved CSoLTE resources in LTE and between the PMSC 24 and e.g. the legacy part of the CS CN,

2. SAE/MME attached via LTE, and

has the needed LTE/SAE bearers that are used as CSoLTE resources. As part of these bearers the terminal holds an IP-address in the GGSN/AGW.

FIG. 6 illustrates schematically the Handover CSoLTE to CS before execution in the case of scenario 1.

Note 1: the CS domain may consist of MSC-S and MGW or may alternatively consist of classical MSC/VLR nodes. This is of no relevance for this invention.

Note 2: The term “scenario” is used in this document to describe different deployment alternatives and scenarios. Two different scenarios are described. In the first scenario (named scenario 1) the PMSC does not have the capability to act as a traditional MSC (i.e. serving and controlling also 2G/3G RANs).

### Scenario 1

The first scenario assumes that the serving PMSC does not have the capability to act as a traditional MSC. This may be the case in the early introduction of LTE/SAE, but it can be assumed that at a later deployment phase all PMSCs will have also MSC capability.

The following actions need to take place when or before handover from CSoLTE solution to traditional CS domain (i.e. 2G/3G RAN) can take place:

1. The eNodeB in LTE need to be aware of that the terminal is engaged in CSoLTE call and preferably which LTE/SAE bearers are used for this call. How this can be solved is described below.

2. The path in the CN between MSC controlling the target 2G/3G RAN 41 and PMSC 24 needs to be established. The current PMSC 24 will act as an anchor point at this handover. For this action the target GERAN/UTRAN cells are identified as normally for CS handovers in legacy systems.

3. The CS bearer in the 2G/3G RAN 41 need to be prepared for this terminal. The eNodeB 23 commands the terminal 31 to move to the CS (and PS) resources in the target 2G/3G RAN 41.

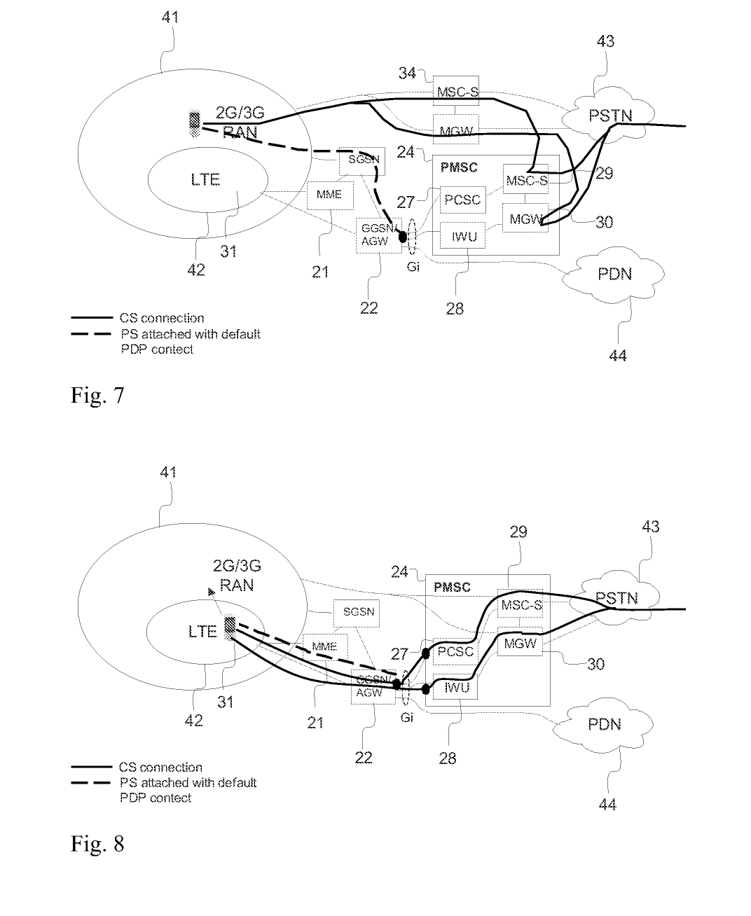

FIG. 7 shows the handover from CSoLTE to CS after Execution under scenario 1.

### Scenario 2

In the second scenario, the PMSC is also capable of functioning as a traditional MSC.

In this case, instead of handling the handover from LTE/SAE as inter-MSC handover case, this can be handled as intra-MSC, inter-system handover. This is also possible today between GSM and WCDMA RANs.

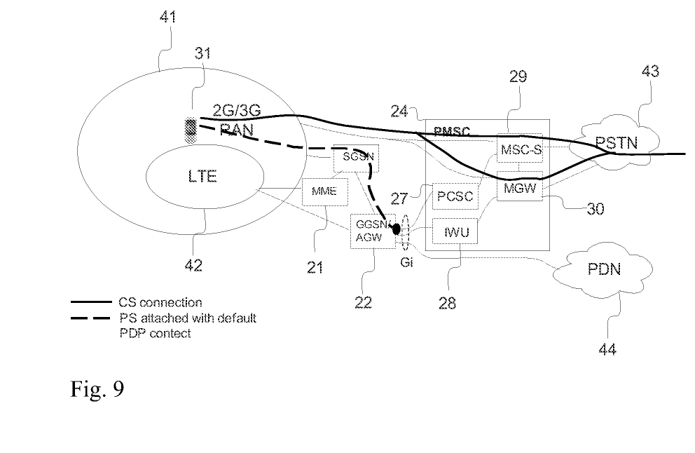

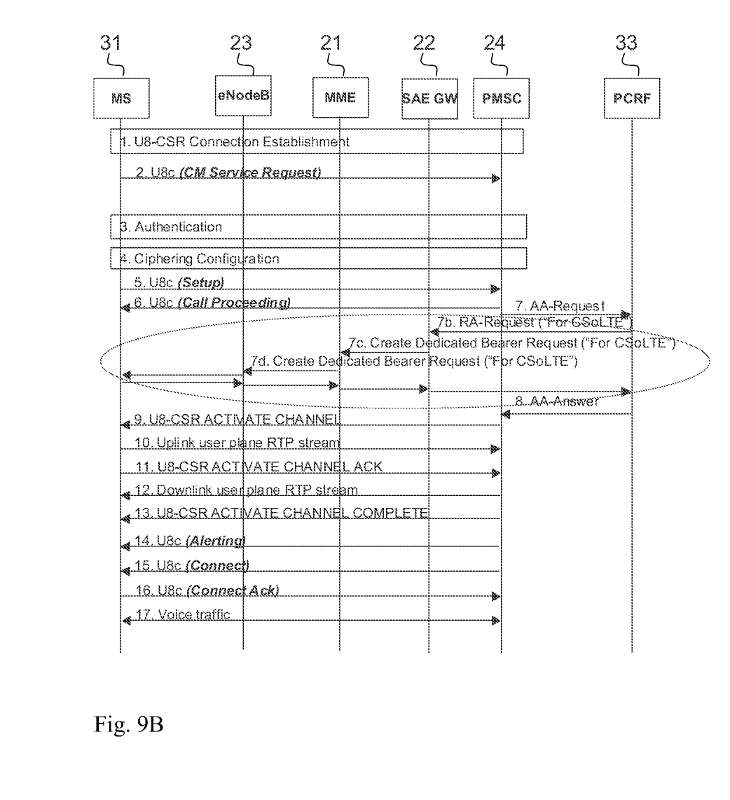

The handover procedures are very similar as in scenario 1, the only difference is that no non-anchor MSC is needed and therefore also no user plane connection between MSCs is needed. The scenario 2 is further shown in FIGS. 8 and 9.

FIG. 8 illustrates the handover from CSoLTE to CS before execution—scenario 2

FIG. 9 illustrates the handover from CSoLTE to CS after execution—scenario 2

### The ENodeB Awareness of Terminal Being Engaged In CSoLTE Call

One of the main problems to be solved for the Handover from CSoLTE to traditional CS domain is to make sure that the eNodeB 23 in LTE 42 is aware that a terminal 31 is engaged in CSoLTE call and preferably also which LTE/SAE bearers are used for the CSoLTE call. If the eNodeB is not aware of this, then it would be difficult to know when it is time to trigger normal PS handover or Handover from CSoLTE to traditional CS domain.

There are two possibilities to solve this. The first option is that the terminal 31 informs the eNodeB 23 directly when CSoLTE calls are being established or released. In this case the terminal 31 can also inform which LTE/SAE bearers are being used for the CSoLTE call.

The second option is that the SAE bearer establishment contains a flag/indication for the use of “CSoLTE” application. This would mean that when the PMSC 24 authorizes media (e.g. a PDP context) over the Rx-interface, then an indication about the application using the requested resources is also included and forwarded in the following requests between the SAE and LTE nodes and finally eNodeB 23 becomes aware of that the CSoLTE application is using the requested resources. This in principle means that the PDP context is marked as being used for “CSoLTE” application. This is further depicted in the following FIG. 9B and shown in combination with a Mobile Originated call. The same principle applies also for the Mobile Terminated calls. The new steps are shown in FIG. 9B using number 7b, 7c and 7d. In addition the step 7 may be modified to include the “For CSoLTE” indication already from the PMSC. When the eNodeB receives the message in step 7d indicating that a dedicated bearer is requested for the CSoLTE application, it can use this information for the duration of the call to decide whether the handover described in this document should be triggered.

Once the eNodeB knows that a CSoLTE call is active and which LTE/SAE bearers are used, it will be able to trigger the Handover from CSoLTE to traditional 2G/3G RAN as needed. The knowledge about which LTE/SAE bearer is being used for the CSoLTE call can be used to not trigger PS handover for these resources. This can be performed if there are LTE/SAE bearer(s) that are used solely for CSoLTE as the CSoLTE parts will be transferred to the CS domain of the target cell and there is no need for these PS resources in the target 2G/3G RAN.

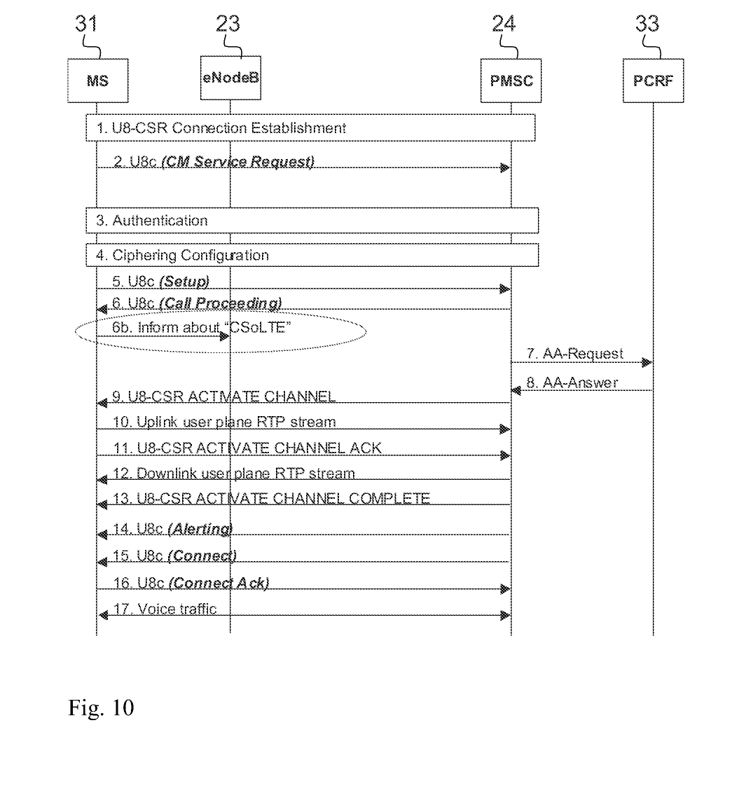

FIG. 10 shows one example of the first option for Mobile Originated (MO) call using the CSoLTE solution. The main interesting part is step 6b where the terminal 31 informs the eNodeB23 about “CSoLTE”. If the terminal 31 should also inform the eNodeB 23 about the LTE/SAE bearers that are used for CSoLTE, then this step would need to take place later, after the steps 7 and 8 which result in an LTE/SAE bearer being created/activated for the terminal.

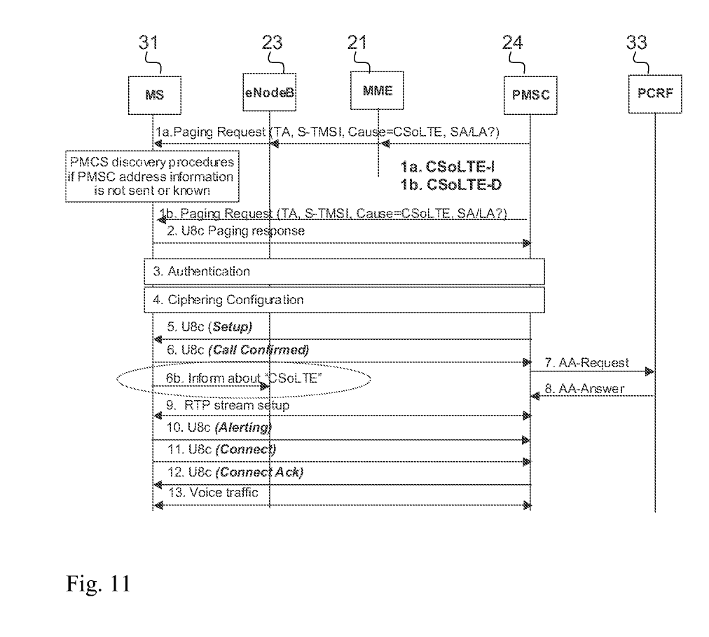

FIG. 11 shows another example of the first option for Mobile Terminated (MT) call using the CSoLTE solution. The main interesting part is the same as in FIG. 10 i.e. step 6b where the terminal 31 informs the eNodeB 23 about “CSoLTE”. If the terminal should also inform the eNodeB about the LTE/SAE bearers that are used for CSoLTE, then this step would need to take place later, after the steps 7 and 8 which result in LTE/SAE bearer being created/activated for the terminal.

FIG. 11. MT call using CSoLTE: Terminal informs the eNodeB about “CSoLTE call”

### The Procedure For Handover From CSoLTE To UTRAN CS

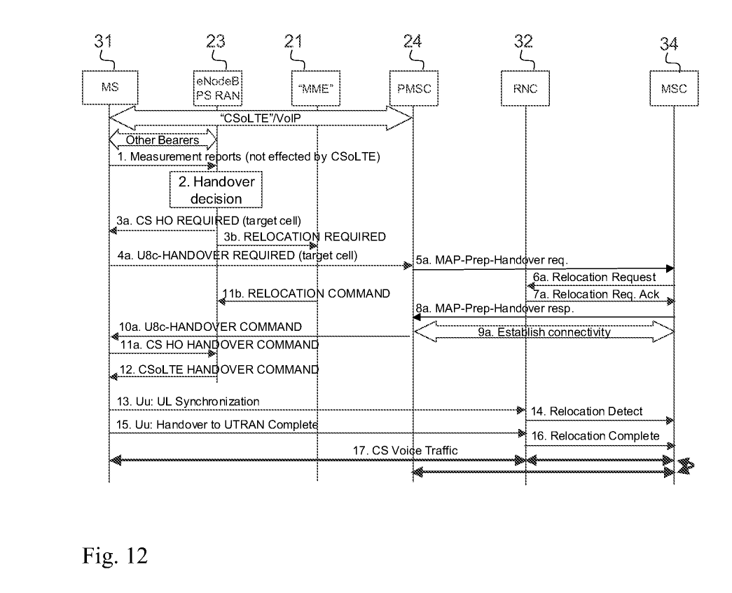

FIG. 12 shows the relevant steps that are needed when a terminal 31 occupied in a

CSoLTE call is moving from LTE to 3G RAN for the scenario 1 case when the serving MSC for the target 3G cell is not the PMSC. The steps shown in the sequence diagram for handover from CSoLTE to UTRAN CS in the case of scenario 1 illustrated in FIG. 12 are described in the following.

Initial State: The mobile station 31 is engaged in a CS call in the CSoLTE solution. The mobile station 31 has dedicated LTE/SAE bearers allocated and these bearers could be only for the CSoLTE or also for other applications. The eNodeB 23 also knows that the mobile station 31 is engaged in CSoLTE call (as described above) The mobile station 31 is configured to perform measurements of neighbouring cells and at least one of the cells to be measured is an 3G/UTRAN cell. The mobile station 31 moves to the coverage area of the UTRAN cell and detects that cell. Simultaneously, the LTE coverage is deteriorating.

Step 1: The mobile station 31 reports the measurements it has performed for the detected UTRAN cell. The exact details of this are not standardized yet, but it can be assumed that the UTRAN cells are measured and reported as Inter-RAT (IRAT) cells in LTE.

Step 2: The eNodeB 23 decides to perform Handover from CSoLTE to the 3G RAN to the reported UTRAN cell. This decision is based on the knowledge of the terminal being engaged in CSoLTE call and that the reported target cell is an UTRAN cell. The following description is divided to two different parts, the CS handover and PS handover parts that are both triggered for the Handover from CSoLTE to CS procedure. The CS handover is shown as steps 3a-11a and the PS handover is partly shown as steps 3b-11b.

Steps 3b-11b: The eNodeB 23 triggers the PS handover procedure. As this procedure is performed as normally (however not standardized yet), the steps between steps 3b and 11b are not described. At step 11b, the eNodeB waits for the completion of both CS and PS handover procedures until it continues to step 12. There is however one possible difference towards the normal PS handover procedure. The eNodeB may select to not indicate that a LTE/SAE bearer used solely for CSoLTE needs to be moved as part of the PS handover procedure.

Step 3a: The eNodeB 23 communicates to the terminal 31 that a CS Handover procedure from CSoLTE to 3G RAN is to be triggered by sending the CS HO REQUIRED message to the terminal. The target UTRAN cell is identified also in the message using one of the existing ways to do this (i.e. i) PLMN-ID, LAC, RNC-ID and Cell Identifier, or ii) RNC-ID and Cell Identifier or iii) LAC, RNC-ID and Cell Identifier, or (iv) PLMN-ID, LAC and Cell Identifier (a so called Cell Global Identity, CGI)).

The final destination for this message is the serving PMSC 24, but as the eNodeB doesn't know which node is PMSC or it doesn't have any ways to communicate with it (i.e. even if it would know it), the eNodeB sends the message to the terminal 31 which forwards it to the PMSC in step 4a).

Step 4a: The terminal 31 forwards the request for CS handover to the PMSC 24 by sending the U8c-HANDOVER REQUIRED message to the PMSC. The target UTRAN cell information is included in the message.

Step 5a: The PMSC 24 uses the target cell identifier received in the U8c-HANDOVER

REQUIRED message to identify the target MSC 34 for this handover request. In this case, the analysis points to the MSC and the relevant MAP signaling (MAP-Prep-Handover-Request) is triggered towards the MSC.

Step 6a-7a: The target MSC 34 requests the target RNC 32 to allocate necessary CS resources for a relocation to the target cell. The target RNC informs the target MSC about the successful result of the CS resource allocation for the requested relocation.

Step 8a: The target MSC 34 uses MAP signaling to communicate towards the source PMSC 24 (MAP-Prep-Handover-Response) that the CS relocation preparation has been performed.

Step 9a: In this step the needed connectivity is established between the PMSC 24 and the target MSC using standard CS call control signaling.

Step 10a: The PMSC 24 informs the terminal that CS handover has been prepared successfully by sending the U8c-HANDOVER COMMAND message to the terminal.

Step 11a: The terminal 31 forwards the received indication to the eNodeB 23 by sending the CS HANDOVER COMMAND to the eNodeB. As this specific handover is about handover from LTE and CSoLTE, the eNodeB needs to wait for both the steps 11a and 11b to happen before it can command the mobile station 31 to move to the target UTRAN cell.

Step 12: The eNodeB builds a “CSoLTE HANDOVER COMMAND” message and sends this message to the terminal. This message is a combination of the information retrieved as part of the performed PS and CS handover preparations.

Step 13: The mobile station 31 accesses the target UTRAN cell using the mechanisms specified for normal hard handover.

Step 14: The target RNC 32 informs the CN that the relocation execution trigger has been received.

Step 15: The terminal 31 sends the Handover to UTRAN Complete message to the target RNC 32 to indicate that the handover to UTRAN has been completed.

Step 16: By sending the Relocation complete message the target RNC 32 informs the CN that the relocation is completed. All performed steps are not shown in FIG. 12, as these are the normal procedures performed after handover.

Step 17: The voice payload is transported to the terminal in the target UTRAN cell.

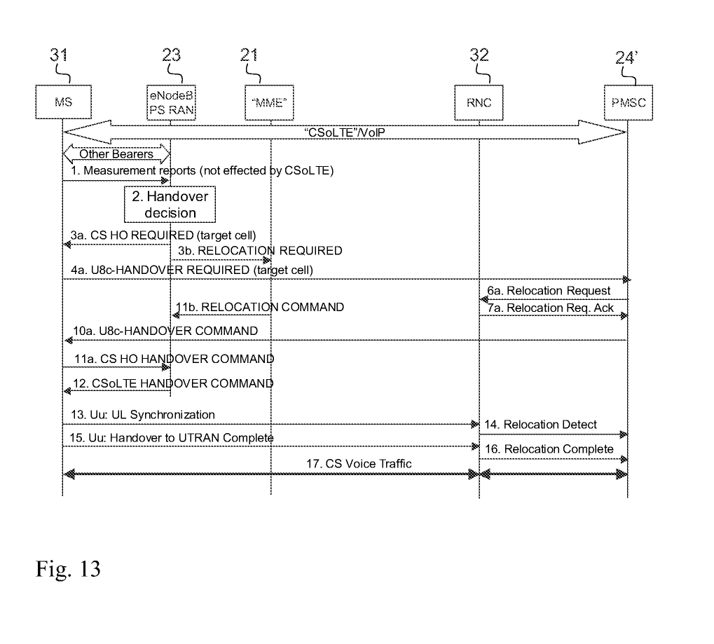

FIG. 13 shows the relevant steps that are needed when a terminal occupied in a CS call is moving from CSoLTE to 3G RAN for the scenario 2 case when the serving PMSC 24′ is also functioning as the target MSC. The description of FIG. 12 applies here also expect that the steps 5a and 8a-9a are omitted.

### The Procedure For Handover From CSoLTE To GSM CS

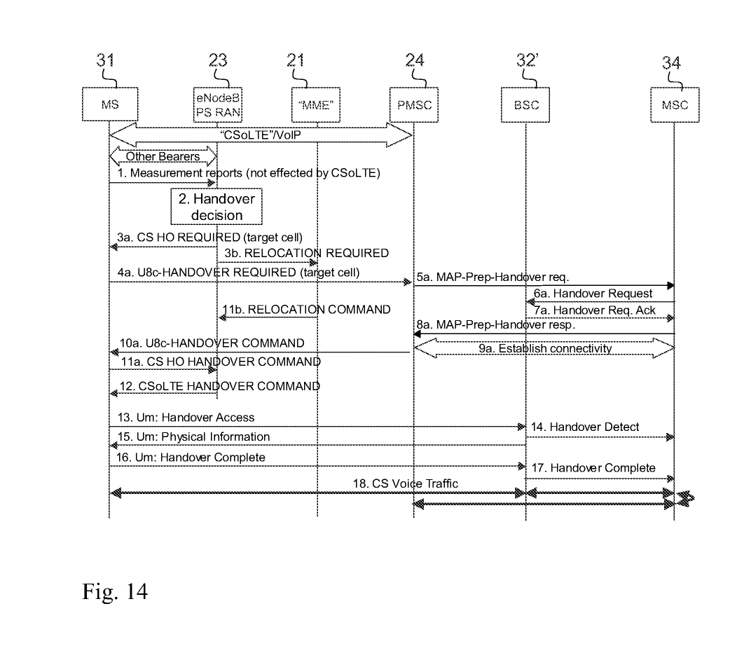

FIG. 14 shows the relevant steps that are needed when a terminal occupied in a CSoLTE call is moving from CSoLTE to GERAN CS. In the initial State the mobile station 31 is engaged in a CS call in the CSoLTE solution. The mobile station 31 has dedicated LTE/SAE bearers allocated and these bearers could be only for the CSoLTE or also for other applications. The eNodeB also knows that the mobile station 31 is engaged in CSoLTE call (as described above). The mobile station 31 is configured to perform measurements of neighbouring cells and at least one of the cells to be measured is a GERAN cell. The mobile station 31 moves to the coverage area of the GERAN cell and detects that cell. Simultaneously, the LTE coverage is getting worse.

Step 1: The mobile station 31 reports the measurements it has performed for the detected GERAN cell. The exact details of this are not standardized yet, but it can be assumed that the GERAN cells are measured and reported as IRAT-cells in LTE.

Step 2: The eNodeB decides to perform Handover from CSoLTE to the 2G RAN to the reported GERAN cell. This decision is based on the knowledge of the terminal being engaged in CSoLTE call and that the reported target cell is a GERAN cell. The following description is divided to two different parts, the CS handover and PS handover parts that are both triggered for the Handover from CSoLTE to CS procedure.

The CS handover is shown as steps 3a-11a and the PS handover is partly shown as steps 3b-11b.

Steps 3b-11b: The eNodeB 23 triggers the PS handover procedure. As this procedure is performed as normally (however not standardized yet), the steps between steps 3b and 11b are not described. At step 11b, the eNodeB waits for the completion of both CS and PS handover procedures until it continues to step 12. There is however one possible difference towards the normal PS handover procedure. The eNodeB may select to not indicate that a LTE/SAE bearer used solely for CSoLTE needs to be moved as part of the PS handover procedure.

Step 3a: The eNodeB 23 communicates to the terminal that CS Handover procedure from CSoLTE to 2G RAN is to be triggered by sending the CS HO REQUIRED message to the terminal. The target GERAN cell is identified also in the message using the normal CGI format.

The final destination for this message is the serving PMSC 24, but as the eNodeB doesn't know which node is PMSC or it doesn't have any ways to communicate with it (i.e. even if it would know it), the eNodeB sends the message to the terminal 31 which forwards it to the PMSC 24 in step 4a) This message is sent from the eNode.

Step 4a: The terminal 31 forwards the request for CS handover to the PMSC 24 by sending the U8c-HANDOVER REQUIRED message to the PMSC. The target GERAN cell information is included in the message.

Step 5a: The PMSC 24 uses the target cell identifier received in the U8c-HANDOVER REQUIRED message to identify the target MSC 34 for this handover request. In this case, the analysis points to the MSC and the relevant MAP signaling (MAP-Prep-Handover-Request) is triggered towards the MSC.

Step 6a-7a: The target MSC requests the target BSC 32′ to allocate necessary CS resources for CS handover in the target cell. The target BSC informs the target MSC about the successful result of the CS resource allocation for the requested handover.

Step 8a: The target MSC 34 uses MAP signaling to communicate towards the source PMSC (MAP-Prep-Handover-Response) that the CS handover preparation phase has been performed.

Step 9a: In this step the needed connectivity is established between the PMSC 24 and the target MSC using standard CS call control signaling.

Step 10a: The PMSC 24 informs the terminal that CS handover has been prepared successfully by sending the U8c-HANDOVER COMMAND message to the terminal.

Step 11a: The terminal 31 forwards the received indication to the eNodeB 23 by sending the CS HANDOVER COMMAND to the eNodeB. As this specific handover is about handover from LTE and CSoLTE, the eNodeB needs to wait for both the steps 11a and 11b to happen before it can command the mobile station 31 to move to the target GERAN cell.

Step 12: The eNodeB 23 builds a “CSoLTE HANDOVER COMMAND message and sends this message to the terminal. This message is a combination of the information retrieved as part of the performed PS and CS handover preparations.

Steps 13-17: The mobile station 31 accesses the target GERAN cell using the mechanisms specified for normal CS and PS handovers. All performed steps are not shown in FIG. 14, as these are the normal procedures performed after CS handover.

Step 18: The voice payload is transported to the terminal in the target UTRAN cell.

The present invention may also be used for other VoIP solutions in LTE and the marking in EnodeB could refer to “Realtime CS voice application” instead of “CSoLTE call/application”.

No doubt many other effective alternatives will occur to the skilled person. It will be understood that the invention is not limited to the described embodiments and encompasses modifications apparent to those skilled in the art lying within the spirit and scope of the claims appended hereto.

What is claimed is:

1. A method for initiating handover of a circuit switched service using a packet switched bearer of a mobile station from a packet switched domain to a circuit switched domain in a mobile communications network comprising a radio network and a core network, said method comprising:
communicating to the mobile station that a circuit switched handover procedure is to be initiated, said communication comprising sending a circuit switched handover required message to the mobile station, said circuit switched handover required message comprising identification of a circuit switched handover target cell; and
said mobile station sending a circuit switched handover required message to the circuit switched core network, said handover-required message comprising identification of the handover target cell.

2. The method according to claim 1, wherein the circuit switched core network comprises a packet switching node, the method further comprising said mobile station sending a circuit switched handover required message to the packet switching node in the core network.

3. The method according to claim 1 wherein the radio network comprises a handover-deciding node, said method comprising the handover-deciding node communicating to the mobile station that a circuit switched handover procedure is to be initiated,

4. The method according to claim 3, wherein the handover-deciding node determines whether the mobile station is using packet switched communication services for circuit switched service(s).

5. The method according to claim 4, wherein the mobile station informs the handover-deciding node about the use of a packet switched bearer for circuit switched service(s).

6. The method according to claim 4, wherein a packet switched communication establishment request is forwarded to the handover-deciding node from the System Architecture Evolution (SAE) core network, said packet switched communication establishment request including a flag indicating the use of packet switched bearer for circuit switched service s) to the mobile station.

7. The method according to claim 1, wherein the handover target cell is identified according to one of:
(i) PLMN-ID, LAC, RNC-ID and Cell Identifier; or
(ii) RNC-ID and Cell Identifier; or
(iii) LAC, RNC-ID and Cell Identifier.
(iv) PLMN-ID, LAC and Cell Identifier.

8. The method according to claim 1 further comprising forwarding the received indication to the handover-deciding node.

9. The method according to claim 8, further comprising sending a handover-command message to the mobile station, said handover-command message being a combination of information received.

10. A method for initiating handover of a circuit switched service using a packet switched bearer of a mobile station from a packet switched domain to a circuit switched domain in a mobile communication network comprising a radio network and a core network, said method comprising:
the mobile station receiving a communication that a circuit switched handover procedure is to be initiated, said communication comprising a circuit switched handover required message, said circuit switched handover required message comprising identification of a circuit switched handover target cell;
said mobile station sending a circuit switched handover required message to the circuit switched core network, said handover-required message comprising identification of the handover target cell.

11. A mobile station adapted for assisting in initiating handover of a circuit switched service using a packet switched bearer of the mobile station from a packet switched domain to a circuit switched domain in a mobile communication network comprising a radio network and a core network, the mobile station comprising:
means for receiving a communication that a circuit switched handover procedure is to be initiated, said communication comprising a circuit switched handover required message, said circuit switched handover required message comprising identification of a circuit switched handover target cell; and
means for sending a circuit switched handover required message to the core network, said handover-required message comprising identification of the handover target cell.

12. The mobile station according to claim 11, the mobile station further comprising means for informing the handover-deciding node about the use of a packet switched bearer for circuit switched call(s).

13. A method for initiating handover of a circuit switched service using a packet switched bearer of a mobile station from a packet switched domain to a circuit switched domain in a mobile communications network comprising a radio network, a handover-deciding node and a core network, said method comprising:
the handover-deciding node determining whether the mobile station is using packet switched communication services; and
the handover deciding node sending a communication to the mobile station indicating that a circuit switched handover procedure is to be initiated, said communication comprising a circuit switched handover required message, said circuit switched handover required message comprising identification of a circuit switched handover target cell.

14. The method according to claim 13, wherein the handover-deciding node receives information from the mobile station about its use of the packet switched bearer for circuit switched call(s).

15. The method according to claim 13, wherein the handover-deciding node receives a packet switched communication establishment request from the SAE core network, said packet switched communication establishment request including a flag indicating the use of packet switched bearer for circuit switched service(s) to the mobile station.

16. The method according to claim 13, wherein the handover target cell is identified according to one of:
(i) PLMN-ID, LAC, RNC-ID and Cell Identifier; or
(ii) RNC-ID and Cell Identifier; or
(iii) LAC, RNC-ID and Cell Identifier.
(iv) PLMN-ID, LAC and Cell Identifier (a so called Cell Global Identity, CGI)

17. A handover-deciding node adapted to assist in initiating handover of a circuit switched service using a packet switched bearer of a mobile station from a packet switched domain to a circuit switched domain in a mobile communications network comprising a radio network, and a core network, the handover-deciding node comprising:
means for determining whether the mobile station is using packet switched communication services; and
means for sending a communication to the mobile station indicating that a circuit switched handover procedure is to be initiated, said communication comprising a circuit switched handover required message, said circuit switched handover required message comprising identification of a circuit switched handover target cell.

18. The handover-deciding node according to claim 17 adapted to operate in accordance with claim 13.
